(19) United States
(12) Patent Application Publication
(10) Pub. No.: US 2008/0128063 A1
(43) Pub. Date: Jun. 5, 2008

(54) Pneumatic Tire

(75) Inventor: Masaaki Ohara, OSAKA (JP)

Correspondence Address: FISH & RICHARDSON P.C., P.O. BOX 1022, MINNEAPOLIS, MN, 55440-1022, US

(73) Assignee: TOYO TIRE & RUBBER CO., LTD., OSAKA (JP)

(21) Appl. No.: 11/943,026

(22) Filed: Nov. 20, 2007

(30) Foreign Application Priority Data
Dec. 1, 2006 (JP) 2006-325310

(51) Int. Cl. B60C 11/13

(52) U.S. Cl. 152/209.19

(57) ABSTRACT

A pneumatic tire is provided which can realize an increase in stone-catching resistance while suppressing uneven wear such as river wear in a tread portion. In a pneumatic tire in which a center rib and intermediate ribs which are defined by four straight-line main grooves, which extend continuously in a circumferential direction of the tire and shoulder ribs which are defined by the main grooves which are situated closer to shoulders of the tire and straight-line thin grooves which extend continuously in the circumferential direction of the tire in the vicinity of tread ground-contacting edges are formed on the surface of a tread of the tire, inclination angles of a shoulder side groove wall of the main groove which defines the shoulder rib and a tire's equator line side groove wall of the thin groove are both such an angle that the shoulder side groove wall and the tire's equator line side groove wall are inclined at an angle of not more than five degrees in a direction in which the width of a proximal portion of the rib is expanded relative to normal lines to the tread.

### BACKGROUND OF THE INVENTION

1. Field of the Invention

The present invention relates to a pneumatic tire of a rib pattern having a plurality of land portions which continue substantially in a circumferential direction of the tire and more particularly to a pneumatic tire which can realize an increase in the stone-catching resistance while suppressing uneven wear, such as river wear, in a tread portion thereof.

2. Description of Related Art

Conventionally, since heavy-load radial tires which are used for trucks and buses are made highly rigid by disposing a belt layer made up of metallic cords in a tread portion and are used with high inflation pressure, with different crown radii R imparted to the tread portion in a tire rotational axis direction, a slipping amount in both shoulder regions to a road surface tends to be increased compared with a central region of the tread portion, and due to this, uneven wear is liable to occur in shoulder-side ribs. As a countermeasure against such uneven wear, circumferentially extending thin grooves are provided in locations in the shoulder-side ribs which lie in the vicinity of ground-contacting edge portions of the tread. In addition, in order to counteract the uneven wear which occurs in edge portions of the ribs, such as river wear, pneumatic tires have been proposed in, for example, JP-A-3-208707 and JP-A-2002-512575, in which a large number of sipes are provided in side walls of grooves in edge portions of ribs in such a manner as to be made to open in width direction.

However, in the event that the width of the rib is increased with a view to increasing wear resistance, the crown R tends to change easily in such a manner that the tread bends outwards in the radial direction of the tire with a shoulder-side main groove functioning as a fulcrum, and there were cases where even though the aforesaid thin grooves were provided in the vicinity of the ground-contacting edge portions of the tread, the bending of the tread was not sufficiently counteracted.

On the other hand, with tires of the rib pattern, circumferential relatively deep grooves of a V-shaped cross section are adopted in order to increase the drainage in the tread, and due to this surface configuration, stones are easily caught in the grooves, and once stones are so caught, the stones are forced deep into the grooves towards bottoms thereof every time such a stone catching portion of the tire is brought into contact with the ground, leading to a problem that the stones tend to constitute a cause for a tire failure such as cracking in the bottom of the groove, ending up with the damaged tread portion.

With a view to preventing the catching of stones in the circumferential grooves, pneumatic tires are proposed in, for example, Japanese Patent Application Kokai 2000-185525, and Japanese Patent Application Kokai 2001-55013, in which a plurality of elongated narrow projections or projecting portions whose circumferential length ranges from 5 to 100 mm are provided circumferentially at intervals of 0.5 to 20 mm on a bottom surface of the circumferential grooves of the tread. However, the tires so proposed do not have any means for suppressing effectively uneven wear in the tread portion thereof.

In a main groove of the rib pattern, in order to cope with the catching of stones, the cross section of the main groove is twisted leftwards and rightwards towards the bottom of the groove or the inclination angle of groove walls is set to a large angle. However, in the event that the inclination angle is increased, although the stone-catching resistance are improved, the ground contact pressure at a ridge portion of the rib is increased, whereby a local uneven wear such as river wear is generated. On the contrary, in the event that the inclination angle is decreased, the opposite tendency appears, and thus, it has been difficult that increasing the stone-catching resistance is made compatible with suppressing the uneven wear.

### BRIEF SUMMARY OF THE INVENTION

The invention has been made in view of the situations described above and an object thereof is to provide a pneumatic tire which can realize an increase in the stone-catching resistance of the tire while suppressing uneven wear, such as river wear, in a tread portion thereof.

According to an embodiment of the invention, there is provided a pneumatic tire including a plurality of ribs which are defined by a plurality of straight-line main grooves which extend continuously in a circumferential direction of the tire and shoulder ribs which are defined by the main grooves which are situated on shoulder sides of the tire and straight-line thin grooves which extend continuously in the circumferential direction of the tire in the vicinity of ground-contacting edges of a tread, the plurality of ribs and the shoulder ribs being formed on a surface of the tread, wherein inclination angles of a shoulder side groove wall of the main groove which defines the shoulder rib and a tire's equator line side groove wall of the thin groove are both such an angle that the shoulder side groove wall and the tire's equator line side groove wall are inclined at an angle of not more than 5 degrees in a direction in which the width of a proximal portion of the rib is expanded relative to normal lines to the tread.

In the pneumatic tire, the main groove which defines the shoulder rib has a rising portion which rises in a central portion of a bottom of the groove, and sipes whose width ranges from 0.5 to 1.0 mm and which are made to open in a tire width direction are provided circumferentially at intervals of 3 to 6 mm on at least one of groove walls of the main groove. The sipes are preferably opened such that the opening length from the groove wall into the rib is length of 0.7 to 1.4 times for the intervals of the sipes, and that a bottom portion of the sipe is situated further radially inwards than an apex portion of the rising portion.

In addition, the pneumatic tire may be such that the rising portion rises while extending continuously in the circumferential direction of the tire, and additionally, the rising height of the rising portion is 0.4 to 0.7 times for the depth of the groove.

In addition, a radius of curvature of a closed end portion of the sipe on the tread surface of the tire is preferably one-half of a maximum width of the sipe.

Furthermore, in the pneumatic tire of the embodiment of the invention, the groove width of the thin groove is in the range of 1.5 to 4.0 mm, and the groove depth thereof is preferably made deeper than at least the depth of the main groove which defines the shoulder rib.

With the pneumatic tire of the embodiment of the invention, since the inclination angles of the shoulder side groove wall of the main groove which defines the shoulder rib and the tire's equator line side groove wall of the thin groove are both such an angle that the shoulder side groove wall and the tire's equator line side groove wall are inclined at an angle of not more than 5 degrees in the direction in which the width of a proximal portion of the rib of the shoulder rib is expanded relative to the normal line to the tread, a compression force which the rib receives when the rib contacts the ground can be dispersed so as to increase the wear resistance. Note that the normal line to the tread or the tread normal line means a normal to a tangent drawn to the tread at a main groove side edge portion or a thin groove side edge portion of the shoulder rib in an unloaded state of the tire with the tire mounted on a standard rim described in the TRA (The Tire and Rim Association) and a standard inflation pressure loaded in the tire.

In addition, since the main groove which defines the shoulder rib has the rising portion which rises in the central portion of the bottom of the groove and the sipes whose width ranges from 0.5 to 1.0 mm and which are made to open in the tire width direction are provided circumferentially at intervals of 3 to 6 mm on at least one of the groove walls of the main groove, the deformation of the shoulder rib is suppressed by increasing the rigidity of the bottom of the groove by the rising portion so provided, whereby the shoulder rib is prevented from being deformed about the main groove functioning as a fulcrum in such a way as to follow the road surface when the rib contacts the ground, and this prevents the shoulder rib side groove wall from being caught in the deformation to thereby suppress the increase in ground contact pressure, which would otherwise be increased. In addition, voids produced in the rib by the sipes function to absorb compressed deformation due to an increase in ground contact pressure, if any, so as to suppress uneven wear such as river wear which would otherwise generated in rib edge regions. Consequently, in case the intervals at which the sipes are disposed are wide, such deformation cannot be absorbed sufficiently, whereby uneven wear is developed in central portions between the sipes. On the contrary, in case the sipe intervals are too narrow, since rubber between the sipes is easily worn, the sipes are preferably opened such that the opening length from the groove wall into the rib is length of 0.7 to 1.4 times for the intervals of the sipes.

In addition, since the rising portion is provided, the intrusion of stones into the groove is prevented, so as to increase the stone-catching resistance, and since the bottom portion of the sipe is situated further radially inwards than the apex portion of the rising portion, the uneven wear suppressing effect can be maintained over a long period of time, and should stones be caught in the groove, the concentration of stress towards the bottoms of the sipes can be avoided so as to suppress the generation of cracks.

Additionally, since uneven wear at the shoulder edge regions is promoted by a lateral force generated when the vehicle turns, the thin groove provided in the vicinity of the tread ground-contacting edge is formed such that the depth of the thin groove becomes deeper than at least the depth of the main grove which defines the shoulder rib, whereby the uneven wear suppressing effect can be maintained until a final stage of the wear.

### BRIEF DESCRIPTION OF THE DRAWINGS

FIG. 1 is a plan view showing a deployed tread pattern of an embodiment of the invention.

FIG. 2 is a sectional view taken along a width direction of a tread.

FIG. 3 is an enlarged view showing a partial section of a shoulder rib portion.

### DETAILED DESCRIPTION OF THE INVENTION

Hereinafter, an embodiment of the invention will be described based on the drawings. In this embodiment, although a large-sized, heavy-load tire for trucks and buses will be described as an example, the invention is not limited to the embodiment in any way.

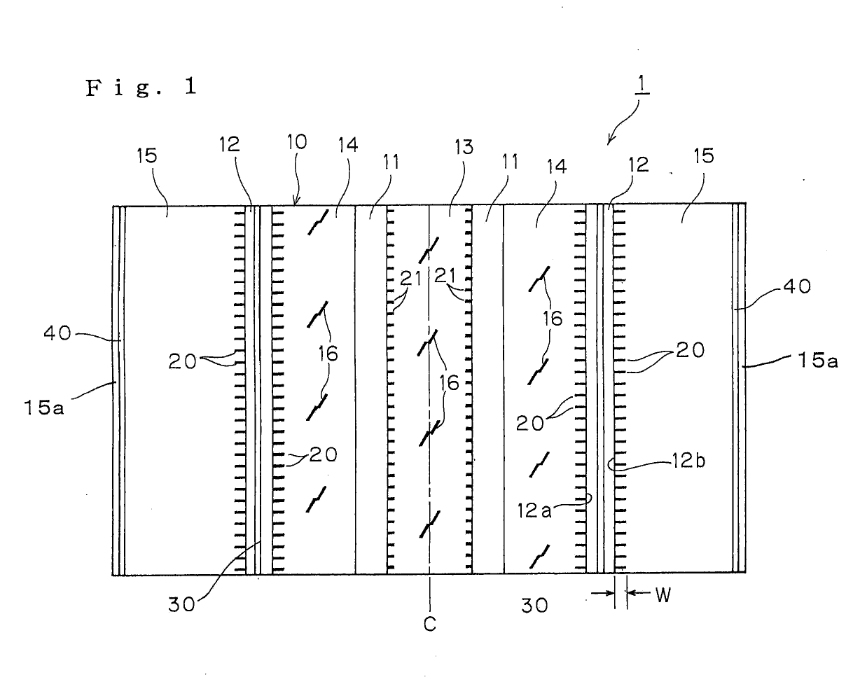

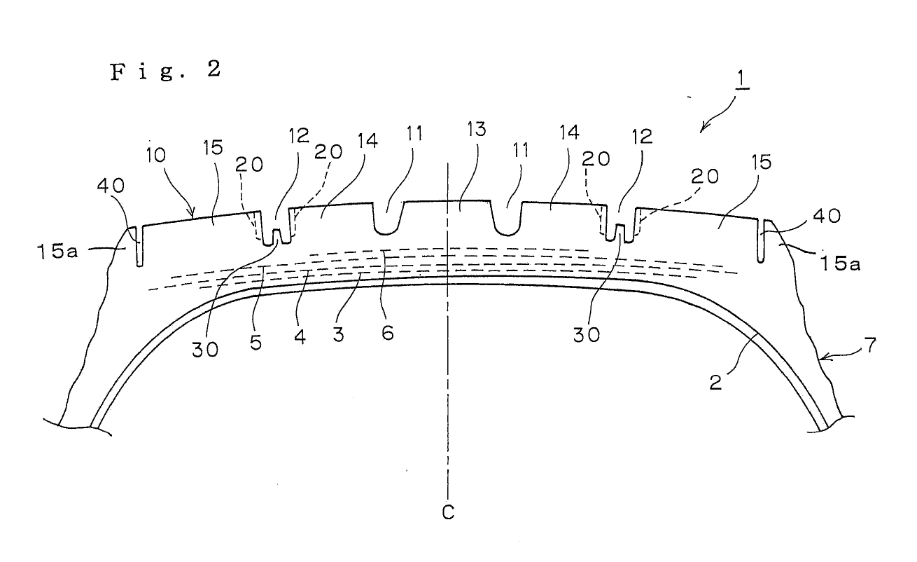

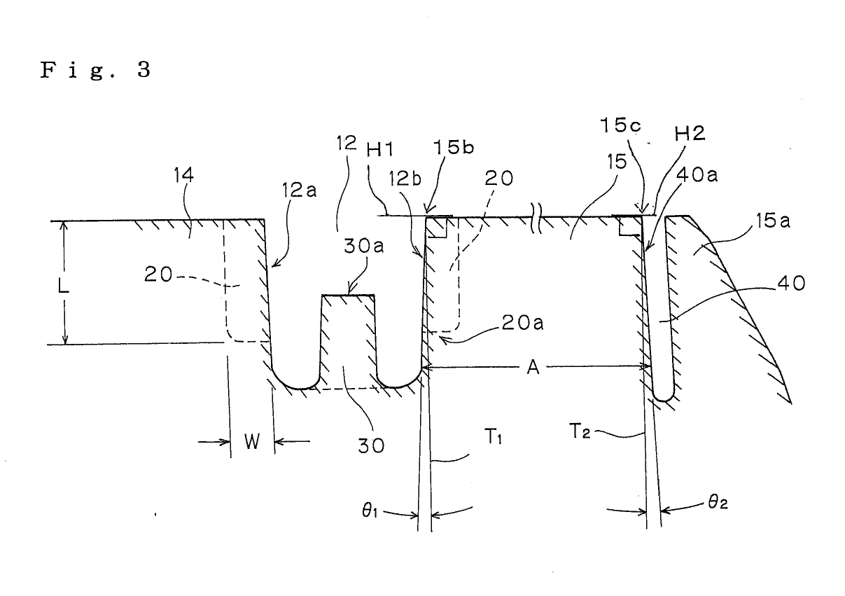

FIG. 1 is a plan view showing a deployed tread pattern of a pneumatic tire 1 of a size of 295/75R22.5 (hereinafter, referred, from time to time, to simply as a tire) which represents an embodiment of the invention. FIG. 2 is a sectional view taken along a width direction of a tread, and FIG. 3 is an enlarged view of a partial section of a shoulder rib.

As is shown in FIG. 2, the tire 1 is a pneumatic radial tire having a general internal construction which includes a radial carcass 2 which employs steel cords which are held to bead cores (not shown) of a pair of bead portions, a belt made up of four belt plies 3, 4, 5, 6 which employ steel cords disposed in a crown portion thereof, a tread 10 which encloses an outer circumference of the belt, side wall portions 7 which follow the tread 10, respectively, and the like, and hence, a detailed description thereof will be omitted here.

In the figures, in the tread 10, a center rib 13 which is situated on an equator line C of the tire and intermediate ribs 14 which are situated on both sides of the center rib 13 are defined by four main groves, equator line side main grooves 11 and shoulder side main grooves 12 which extend continuously in a circumferential direction of the tire in symmetrical positions relative to the equator line C.

In addition, straight-line thin grooves 40 which extend continuously in the circumferential direction of the tire and have a groove width ranging from 1.5 to 4.0 mm are provided in the vicinity of tread ground-contacting edges, so that shoulder ribs 15 which are defined by the shoulder side main grooves 12 and the thin grooves 40 are formed to lie, respectively, outside of the intermediate ribs 14. Thus, the respective ribs 13, 14, 15 define land portions which extend continuously in the circumferential direction of the tire.

Additionally, in transverse rib central portions of the center rib 13 and the intermediate ribs 14 in the tire 1 shown in FIG. 1, closed sipes 16 of a lighting flash shape which terminates within the respective rib regions are formed at certain intervals in the circumferential direction of the tire. Although the closed spies are illustrated in this embodiment, open sipes may be provided in which sipes are made to open to at least one of the main grooves 11, 12, or both the closed and open sipes may be adopted together. The compressed deformation of the ribs is absorbed by the sipes which are configured as described above, so as to reduce the ground contact pressure of the ribs to thereby increase the wear resistance thereof.

In addition, a large number of sipes 21 are disposed on both groove walls of the center rib 13 in such a manner as to be aligned in the circumferential direction of the tire at certain intervals, and the sipes 21 are made to open in the width direction of the tire with one end thereof made to open to the main grooves. These sipes 21 function to absorb the compressed deformation of the rib 13 attributed to a rise in a ground contact pressure which is applied to a ridge of the rib 13 when the rib contacts the ground, thereby making it possible to suppress uneven wear that would otherwise be generated in edge portions of the rib.

In the tire 1 of the embodiment of the invention, as is shown in FIG. 3, a shoulder side groove wall 12b of the main groove 12 which defines the shoulder rib 15 and an equator line side groove wall 40a of the thin groove 40 are both set to be inclined in a direction in which the width A of a proximal portion of the shoulder rib 15 is expanded. Inclination angles θ1, θ2 of the respective groove walls are both set to be more than zero degrees but not more than five degrees relative to tread normal lines T1, T2 to tangents H1, H2 which are drawn to the tread at a main groove side edge portion 15b or a thin groove side edge portion 15c of the shoulder rib 15 in an unloaded state of the tire with the tire mounted on a standard rim described in the TRA and a standard inflation pressure loaded in the tire.

This is because the shoulder rib 15 is made more liable to suffer from compression force when it contacts the ground as the inclination angles of the groove walls 12b, 40a which define the shoulder rib 15 are large, so as to facilitate wear due to deformation of rubber which makes up the tread, and on the contrary, in the event that the relevant groove walls are inclined in such a manner that the respective edge portions 15a, 15b of the rib 15 overhang the corresponding grooves, no force cannot be applied to ridges of the main groove 12 and the thin groove 40 to generate slippage, so as to facilitate the occurrence of wear. Consequently, the groove walls 12b, 40a which define the shoulder rib 15 are preferably set so as to be as close to perpendicular to the tread surface as possible while producing no such overhang. The range of inclination of the groove walls is defined by the fact that the groove walls are inclined at the angle which is more than zero degree but not more than five degrees relative to the tread normal lines T1, T2, whereby, an advantage is obtained that in particular, the wear resistance of the overall tread surface of the shoulder rib 15 is increased.

The groove width of the thin groove 40 is preferably in the range of 1.5 to 4.0 mm. In the event that the groove width becomes narrower than 1.5 mm, since the thickness of a blade provided in a mold to form the groove inevitably becomes thin, there is caused a problem regarding the durability of the mold, and a shoulder ground-contacting edge region 15a lying transversely outwards of the thin groove is pressed against the shoulder rib 15 by virtue of a lateral force generated when the vehicle turns, whereby the ground contact pressure at the edge portion of the shoulder rib 15 against which the shoulder ground-contacting edge region 15a is pressed is increased, facilitating the propagation of a local wear. On the contrary, in the event that the groove width becomes wider than 4.0 mm, the rubber amount of the whole of the shoulder portion is made difficult to be secured, whereby not only the wear resistance is affected but also the widened groove tends to easily catch relatively big stones, leading to an increase in occurrence of damages such as cuts and/or cracks in the rubber of the shoulder ground-contacting edge region 15a.

In addition, the groove depth of the thin groove 40 is preferably set to be deeper than at least the depth of the shoulder side main groove 12. This is because the depth of thin groove 40 needs to be made deeper than the depth of the shoulder side main groove 12 so that the uneven wear suppressing effect is maintained until the final stage of wear due to wear being generally promoted at the edge portion of the shoulder by virtue of the lateral force generated when the vehicle turns.

Here, the groove depth of the thin groove 40 is set to be deeper by on the order of 0.5 to 2 mm than the depth of the shoulder side main groove 12. In the event that the difference in depth between the two grooves is less than 0.5 mm, the aforesaid effect cannot be obtained, whereas in the event that the difference becomes larger than 2 mm, the shoulder grand-contacting edge region 15a is made easy to move, whereby the relevant region starts to wear at an early stage of its life and cuts and cracks also occur in the rubber making up the region.

In addition, in the tire 1 of the embodiment of the invention, a large number of sipes 20 each having a width of 0.5 to 1.0 mm are disposed on both groove walls 12a, 12b of the main groove 12 which defines the shoulder rib 15 in the circumferential direction of the tire at certain intervals in such a manner as to be made to open in the width direction of the tire and also to the main groove 12 at one end thereof.

In the event that the width of the sipe 20 is less than 0.5 mm, the radius of curvature at a distal end portion of the sipe cannot be secured, whereby a crack is made easy to be generated from the distal end portion, whereas in the event that the width is wider than 1.0 mm, a rubber region between the sipes is made easy to move independently, and the rubber portion becomes easy to be caught relative to forward and rearward inputs when the tire rotates, whereby there may occur a case where the rubber is torn off.

In addition, a radius of curvature at a closed end portion of the sipe 20 is preferably set to be equal to one-half of a maximum width of the sipe, thereby making it possible to suppress the generation of a crack from the end portion of the sipe.

The sipes 20 are preferably provided in the circumferential direction of the tire at intervals of 3 to 6 mm, whereby voids formed in the ribs 14, 15 by the sipes 20 can absorb compressed deformation generated due to a rise in the ground contact pressure applied to surfaces of the ribs when the ribs contact the ground, thereby making it possible to suppress uneven wear in the edge portions of the ribs 14, 15. In the event that the intervals at which the sipes 20 are provided are wider than 6 mm, such deformation cannot be absorbed, whereby a nucleus functioning as an origin of uneven wear is formed in a central portion between the sipe, and a slippage is generated in the edge portions of the ribs by virtue of a shearing force generated when the ribs contact the ground, whereby uneven wear tends to be caused in the edge portions of the ribs, whereas in the event that the intervals are narrower than 3 mm, the rubber between the sipes 20 is easily torn off, and this causes cuts and cracks in the rubber which makes up the ribs, so that resulting cutouts and cracks so generated constitute an origin of uneven wear, and the quality of the tire on its external appearance is deteriorated.

As to the dimensions of the sipe 20, there should be no specific limitation, provided that an opening length W of the sipe into the ribs 14 and 15 is length of 0.7 to 1.4 times for the intervals of the sipes, but a depth L of the sipe 20 is normally set to be longer than the opening length W. In the event that the opening length W is longer than the intervals at which the sipes are disposed by a factor of less than 0.7, the uneven wear resistance in the edge regions of the ribs is decreased, whereas in the event that the opening length W is longer than the sipe interval by a factor of more than 1.4, a crack is made easy to be generated in the surface of the sipe.

As a dimension example of the sipe 20, ranges of dimensions are illustrated as the opening length W into the ribs ranging substantially from 2 to 5 mm and the depth L ranging substantially from 5 to 10 mm. In the event that the size of the sipe 20 is too small, the designed effect cannot be exhibited, whereas in the event that the size is too large, a crack is generated at the end of the sipe due to input from the road surface, this generating problems that uneven wear is generated and the external appearance quality is damaged.

In addition, a rising portion 30, whose height is 0.4 to 0.7 times for the depth of the shoulder side main groove 12, is provided in a central portion of a groove bottom of the main groove 12.

By this configuration, stones are made difficult to be caught in the main groove 12, and even though stones are caught in the main groove, the stones so caught are forced out of the groove by the rising portion 30, whereby the removal of the stones from the groove is facilitated, the stone-catching resistance being thereby increased.

Additionally, in the event that a rubber thickness of a bottom portion of the shoulder side main groove 12 is thinner than that of the rib portion and, furthermore, that the outermost belt ply 6 is disposed further transversely inwards than the main groove 12, when the rib 14 contacts the ground, the groove wall of the rib 14 swells to be deformed about the groove bottom of the main groove 12 which functions as a fulcrum in such a way as to be caught towards the equator line side, and the tread surface of the rib 14 is caused to move. Therefore, the rigidity at the groove bottom is increased by so providing the rising portion 30, so as to obtain an advantage that the deformation occurring about the groove bottom as the fulcrum can be suppressed.

Although the rising portion 30 may be formed on the groove bottom of the main groove 12 discontinuously with certain intervals, it is preferable to form the rising portion continuously in the circumferential direction of the rite along the groove bottom from the viewpoints of better stone-catching resistance and stress absorption.

The height of the rising portion 30 is 0.4 to 0.7 times for the depth of the main groove 11, and more preferably by a factor of 0.45 to 0.55. In the event that the height is taller by a factor of less than 0.4, the effect of preventing the catching of stones becomes insufficient, and the rigidity at the groove bottom becomes insufficient, whereby the effect becomes small of suppressing the swelling and deformation of the groove wall of the rib 14 about the groove bottom which functions as the fulcrum in such a way as to be caught towards the equator line side. On the contrary, in the event that the height is taller by a factor of more than 0.7, relatively small stones are made easy to be caught in the groove, and the stones so caught are also made difficult to be removed from the groove.

In addition, the width of a bottom portion of the rising portion 30 is preferably wider than the width of a groove bottom of the main groove 11 by a factor of 0.3 to 0.6, and more preferably by a factor of 0.4 to 0.5. In the event that the width of the bottom portion is wider than the width of the groove bottom by a factor of less than 0.3, the required rigidity at the groove bottom cannot be secured, and hence, stones are made easy to be caught in the groove, whereas in the event that the width of the bottom portion is wider by a factor of more than 0.6, the groove bottom R of the main groove 11 is made difficult to be secured, and the generation of cracks in the groove bottom is facilitated.

No specific limitation is imposed on the cross-sectional shape of the rising portion 30, but in general, a trapezoidal shape is adopted.

Here, the position of a bottom portion 20a of the sipe 20 is set to be further radially inwards of the tire than an apex portion 30a of the rising portion 30.

This is because in the event that the depth of the sipes 20 is shallower than the apex portion of the rising portion 30, the sipes 20 disappear as wear propagates, whereby the effect of suppressing uneven wear is lost at an early stage of the life of the tire, and when a stone is caught in the main groove 12, the sipes 20 are deformed by being pressed by the stone so caught, as this occurs, stress is concentrated at the closed end portions of the sipes 20, facilitating the generation of cracks thereat. In this respect, too, the radius of curvature of the sipe end portion, that is, the closed end portion of the sipe 20 should preferably be a radius of curvature which is equal to one-half of a maximum width of the sipe.

By adopting the configuration that has been described heretofore, the tire 1 of the embodiment of the invention can realize an increase in the uneven wear resistance of, in particular, the shoulder rib while improving the stone-catching resistance.

### EMBODIMENT

Hereinafter, the invention will be specifically described based on an embodiment.

The following tire performance evaluations were carried out on prototype tires (radial tires of 295/75R22.5 which were each made up of a steel carcass of one ply and a steel belt of four plies) which were experimentally produced to each have the tread pattern shown in FIG. 1 and to specifications described in Table 1.

The following specifications were made common over the prototype tires produced. The width and depth of main grooves 11, 12 were 11 mm and 12 mm, respectively, and the width of any of sipes 20 opened in both groove walls of the main grooves 12 was 0.6 mm, the radius of curvature of a sipe end portion being 0.3 mm. The height of a rising portion 30 was 6.5 mm, and the rising portion 30 was formed into a trapezoidal shape in cross section in which a width at a bottom side was 5 mm and a width at an upper side was 4 mm and was provided in such a manner as to extend continuously along the full circumference of the tire. The width of a thin groove 40 was 2.8 mm. Note that sipes 20, a rising portion 30 and thin grooves 40 were not provided in a conventional tire used.

### [Uneven Wear Resistance]

The tires were mounted on front wheels (steer wheels) of tractors (2-D) for long-range transport trailers and the tractors were each actually driven to accumulate a mileage of 160,000 km. Thereafter, the tires were measured on a river wear generation area and the results were indicated by index numbers compared with the conventional example taken as 100. Smaller numbers indicate better results.

### [Stone-Catching Resistance]

After the end of the uneven wear resistance tests, the numbers of stones which were caught in the grooves were visually verified, and the results were indicated by index numbers compared with the conventional example taken as 100. Smaller numbers indicate better results.

### [Groove Bottom Cracking Resistance]

After the end of the uneven wear resistance tests, the generation of groove bottom cracking was visually verified.

### [Damage Resistance in Shoulder Ground-Contacting Edge Region]

After the end of the uneven wear resistance tests, the occurrence of damages such as cuts and cracks in rubber to a shoulder ground-contacting edge region lying outwards of the thin groove was visually verified.

### [Cracking Resistance at Sipe Bottom and Sipe Surface Portion]

After the end of the uneven wear resistance tests, the generation of cracks in sipe bottoms and sipe surface portions was visually verified.

TABLE 1

| | Conventional | Embodiment Examples | | | | | Comparison Examples | | | | | |
|---|---|---|---|---|---|---|---|---|---|---|---|---|
| | Example | 1 | 2 | 3 | 4 | 5 | 1 | 2 | 3 | 4 | 5 | 6 |
| Sipe Intervals (mm) | — | 4.5 | 6 | 4.5 | 4.5 | 4.5 | 2.5 | 7 | 4.5 | 4.5 | 4.5 | 4.5 |
| Sipe Length W (mm) | — | 4 | 5 | 4 | 4 | 4 | 4 | 4.5 | 6 | 4 | 4 | 4 |
| Sipe Depth L (mm) | — | 8 | 8 | 10 | 8 | 8 | 8 | 8 | 8 | 4.5 | 8 | 8 |
| Sipe Length W/Sipe | — | 0.71 | 0.83 | 0.89 | 0.89 | 0.89 | 1.60 | 0.64 | 1.33 | 0.89 | 0.89 | 0.89 |
| Interval | | | | | | | | | | | | |
| Difference between Sipe | — | 2.5 | 2.5 | 4.5 | 2.5 | 2.5 | 2.5 | 2.5 | 2.5 | −1 | 2.5 | 2.5 |
| Depth and Rising Portion | | | | | | | | | | | | |
| Height (mm) | | | | | | | | | | | | |
| Thin Groove Depth (mm) | — | 13.5 | 13.5 | 13.5 | 13.5 | 13.5 | 13.5 | 13.5 | 13.5 | 13.5 | 10 | 13.5 |
| Difference between Thin | — | 1.5 | 1.5 | 1.5 | 1.5 | 1.5 | 1.5 | 1.5 | 1.5 | 1.5 | −2 | 1.5 |
| Groove Depth and Main | | | | | | | | | | | | |
| Groove Depth (mm) | | | | | | | | | | | | |
| Inclination of Shoulder | 12 | 4 | 4 | 4 | 0.5 | 4 | 4 | 4 | 4 | 4 | 4 | −2 |
| Main Groove θ1 (degrees) | | | | | | | | | | | | |
| Inclination of Shoulder | 12 | 4 | 4 | 4 | 0.5 | 0.5 | 4 | 4 | 4 | 4 | 4 | −2 |
| Thin Groove θ2 (degrees) | | | | | | | | | | | | |
| Uneven Wear Resistance | 100 | 80 | 80 | 95 | 73 | 80 | 105 | 115 | 110 | 80 | 118 | 113 |
| (index number) | | | | | | | | | | | | |
| Stone-Catching Resistance | 100 | 75 | 75 | 70 | 95 | 95 | 75 | 75 | 60 | 75 | 75 | 110 |
| (index number) | | | | | | | | | | | | |
| Groove Bottom Cracking | Not Verified | Not | Not | Not | Not | Not | Not | Not | Verified | Not | Not | Not |
| Resistance | | Verified | Verified | Verified | Verified | Verified | Verified | Verified | | Verified | Verified | Verified |
| Occurrence of Damages to | Not Verified | Not | Not | Not | Not | Not | Not | Not | Not | Not | Not | Not |
| Shoulder Rib Edge Portion | | Verified | Verified | Verified | Verified | Verified | Verified | Verified | Verified | Verified | Verified | Verified |
| Sipe Bottom Cracking | Not Verified | Not | Not | Not | Not | Not | Not | Not | Not | Verified | Not | Not |
| Resistance | | Verified | Verified | Verified | Verified | Verified | Verified | Verified | Verified | | Verified | Verified |
| Sipe Surface Portion | Not Verified | Not | Not | Not | Not | Not | Verified | Not | Not | Not | Not | Not |
| Cracking Resistance | | Verified | Verified | Verified | Verified | Verified | | Verified | Verified | Verified | Verified | Verified |

From results shown in Table 1, with the tires according to the embodiment of the invention, the generation of river wear was suppressed, the stone-catching resistance was increased while maintaining the uneven wear resistance, and the generation of cracks in the groove bottom and the occurrence of damages to the shoulder ground-contacting edge region could be suppressed.

According to the pneumatic tire of the embodiment of the invention, the stone-catching resistance can be increased while suppressing the generation of uneven wear such as river wear in the ribs lying on the shoulder sides of the tire.

The pneumatic tire of the embodiment of the invention can be applied to tires of various sizes and applications such as tires for passenger cars to large-sized, heavy-load tires for trucks and buses and can be used for steer wheels and drive wheels indifferently. In particular, the tire of the embodiment of the invention is preferably applied to front wheels (steer wheels) of large-sized, heavy-duty vehicles such as trucks, buses, tractors and the like.

1. A pneumatic tire comprising a plurality of ribs which are defined by a plurality of straight-line main grooves which extend continuously in a circumferential direction of the tire and shoulder ribs which are defined by the main grooves which are situated on shoulder sides of the tire and straight-line thin grooves which extend continuously in the circumferential direction of the tire in the vicinity of ground-contacting edges of a tread, the plurality of ribs and the shoulder ribs being formed on a surface of the tread, wherein
inclination angles of a shoulder side groove wall of the main groove which defines the shoulder rib and a tire's equator line side groove wall of the thin groove are both such an angle that the shoulder side groove wall and the tire's equator line side groove wall are inclined at an angle of not more than five degrees in a direction in which the width of a proximal portion of the rib is expanded relative to normal lines to the tread.

2. A pneumatic tire according to claim 1, wherein the main groove which defines the shoulder rib has a rising portion which rises in a central portion of a bottom of the groove, wherein sipes whose width ranges from 0.5 to 1.0 mm and which are made to open in a tire width direction are provided circumferentially at intervals of 3 to 6 mm on at least one of groove walls of the main groove, wherein the sipes are preferably opened such that the opening length from the groove wall into the rib is length of 0.7 to 1.4 times for the intervals of the sipes, and wherein a bottom portion of the sipe is situated further radially inwards of the tire than an apex portion of the rising portion.

3. A pneumatic tire according to claim 2, wherein the rising portion rises while extending continuously in the circumferential direction of the tire.

4. A pneumatic tire according to claim 2 or 3, wherein a rising height of the rising portion is 0.4 to 0.7 times for the depth of the groove.

5. A pneumatic tire according to claim 2, wherein a radius of curvature of a closed end portion of the sipe on the tread surface of the tire is preferably one-half of a maximum width of the sipe.

6. A pneumatic tire according to claim 1, wherein a groove width of the thin groove is in the range of 1.5 to 4.0 mm, and wherein the groove depth thereof is preferably made deeper than at least the depth of the main groove which defines the shoulder rib.
